(19) United States
(12) Patent Application Publication
(10) Pub. No.: US 2023/0365433 A1
(43) Pub. Date: Nov. 16, 2023

(54) SYSTEM AND METHOD FOR THE TREATMENT OF POLLUTED WATERS, IN PARTICULAR WITH HEAVY METALS

(71) Applicant: ECOSPRAY TECHNOLOGIES S.R.L., Voghera (IT)

(72) Inventors: Maurizio Archetti, Terre di Pedemonte - Verscio (CH); Luca Muratori, Pontecurone (IT)

(21) Appl. No.: 18/042,984

(22) PCT Filed: Aug. 26, 2021
(86) PCT No.: PCT/IB2021/057812

§ 371 Date: Feb. 24, 2023

(30) Foreign Application Priority Data
Aug. 27, 2020 (IT) 102020000020536

(51) Int. Cl. C02F 1/28; C02F 1/00; B01D 53/14

(52) U.S. Cl. CPC C02F 1/283; C02F 1/004; B01D 53/1493; C02F 2101/20

(57) ABSTRACT

A system and method of filtering waters contaminated by pollutants, in particular for removing heavy metals from said contaminated waters, said system comprising a duct for the transit of said contaminated waters, said system further comprising a tank of activated carbon powders in communication with said duct for the transit of said contaminated waters by introduction means adapted to introduce said activated carbon powders into said duct.

### CROSS-REFERENCE TO RELATED APPLICATIONS

This application claims priority to PCT International Application No. PCT/IB2021/057812 filed on Aug. 26, 2021, which applications claims priority to Italian Patent Application No. 102020000020536 filed on Aug. 27, 2020, the entire disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention belongs to the field of the treatment of waters contaminated by pollutants. In particular, the present invention belongs to the field of the treatment of contaminated waters containing heavy metals and/or hydrocarbons, in particular Polycyclic Aromatic Hydrocarbons (hereinafter PAHs) and/or powders or particulates. In detail, the present invention belongs to the field of the treatment of contaminated waters used for the abatement of fumes generated by the combustion of fuel oil, in particular heavy oil. Therefore, the present invention relates to a system for treating contaminated waters containing heavy metals and/or hydrocarbons of the aforesaid type and/or powders or particulates resulting from the combustion of fuel oil, in particular heavy oil. The present invention also relates to a method for treating contaminated waters containing heavy metals and/or PAHs and/or powders or particulates resulting from the combustion of fuel oil, in particular heavy oil.

### Background Art

In the field of both commercial and tourist navigation, the use of fuel oil, in particular heavy oil, is widespread for supplying the marine engines of large ships such as cruise ships, ferries, bulk carriers, car carriers, container ships and the like. In particular, heavy metals are present in a certain concentration in the heavy oil (HFO-heavy fuel oil) used as primary fuel for the marine engines of ships of the above type, which do not participate in the combustion and are thus released into the atmosphere. Furthermore, the fumes resulting from the combustion of heavy oil also contain, in varying percentages, hydrocarbons, in particular PAHs and powders or particulate matter.

Following the regulations which came into force on Jan. 1, 2020, in order to be able to burn heavy oil with a sulfur content above 0.5%, ships are obliged to use a scrubber. In the simplest configuration thereof (Open Loop) a pump draws water from the sea, which is used inside a scrubber to remove sulfur oxides and is then discharged into the sea. The washing of fumes which occurs in the scrubber, in addition to capturing the Sox, is also capable of capturing a part of the particulate, which includes heavy metals, ash and hydrocarbons, therefore where the water outflowing from the scrubber and discharged into the sea is full of said heavy metals and/or PAHs and/or powders or particulates.

Therefore, there is the problem, perceived by the applicant of the present patent application, of how to remove or at least reduce the concentration of heavy metals and PAHs (as well as any powders or particulate matter possibly present) from the waters discharged from marine scrubbers before they are poured into the sea, where said heavy metals and/or PAHs may possibly be adhered to solid particles and therefore in suspension, possibly together with powders and/or particulates, in the water discharged from the scrubbers, while a fraction of said heavy metals and/or PAHs, dependent on various factors, is instead dissolved in water.

Obviously, the removal from the water discharged from the scrubbers, both of the heavy metals and/or PAHs adhering to solid particles, and of the powders or particulates in suspension can be performed with filters suitable for the purpose and known per se, while on the contrary, it is not possible to remove heavy metals and/or PAHs in solution, i.e., dissolved in said waters with filters of known type.

Therefore, it is the main object of the present invention to suggest and provide a solution for treating waters polluted by heavy metals and/or PAHs.

It is a further object of the present invention to suggest and provide a solution for treating waters polluted by heavy metals and/or PAHs (and possibly powders or particulate matter) resulting from the combustion of fuel oil, in particular heavy oil.

It is a not last object of the present invention to remove and/or at least reduce the concentration of heavy metals and/or PAHs as well as possibly of powders or particulates from the waters discharged from marine scrubbers before they are poured into the sea.

Finally, it is another object of the present invention to provide a solution of the aforesaid type which can be made and implemented at low cost, which can be implemented in simple and easy-to-execute methods, and which allows the removal or at least the reduction of the concentration of heavy metals and/or PAHs from the waters discharged from different scrubbers and used on different types of ships for treating combustion fumes..

### DESCRIPTION OF THE PRESENT INVENTION

In consideration of both the problems and the objects summarized above, the present invention relates to a filtering system for waters contaminated by pollutants, in particular for removing heavy metals and/or PAHs from said contaminated waters, said system comprising a duct (C) for the transit of said contaminated waters, said system comprising a tank (S) of activated carbon powders in communication with said duct (C) for the transit of said contaminated waters by introduction means (10) adapted to introduce said activated carbon powders into said duct (C), where said system comprises at least one filter (1) for said polluted waters added with said activated carbon powders in communication with said duct (C), said at least a first filter (1) being adapted to separate the products of the absorption of said pollutants by said activated carbon from said contaminated waters and to retain said products of the absorption of said pollutants by said activated carbon.

According to an embodiment, said system comprises at least two of said first filters (1) adapted to separate said products of the absorption of said pollutants by said activated carbon from said contaminated waters and to retain said products of the absorption of said pollutants by said activated carbon, in which said at least two first filters (1) are arranged in parallel and thus alternatively connectable to and isolable from said duct (C).

According to an embodiment, each of said at least two first filters (1) is alternatively connectable to and isolable from said duct (C) by means of at least one valve interposed between each of said at least two first filters (1) and said duct (C).

According to an embodiment, said system comprises means (11) for removing any gases from said duct (C), in which said means (11) for removing said possible gases are put in communication with said duct (C) downstream of the introduction point of said activated carbon powders into said duct (C) and upstream of said at least a first filter (1) for said polluted waters added with said activated carbon powders.

According to an embodiment, said system comprises means for regenerating said at least one filter adapted to remove from said at least a first filter (1) said retained products of the absorption of said pollutants by said activated carbon.

According to an embodiment, said means for regenerating said at least one filter comprise a first pump (2) in communication with said duct (C) downstream of said at least a first filter (1), where said first pump (2) is thus adapted to at least partially withdraw the outcoming waters from said at least a first filter (1), and where said first pump (2) is in communication with said at least a first filter (1) and adapted to reintroduce in counter-flow (counter-current) in said at least a first filter (1) at least part of the outcoming waters from said at least a first filter (1) and therefore to remove from said at least a first filter (1) said retained products of the absorption of said pollutants by said activated carbon.

According to an embodiment, said system comprises a second tank (3) in communication with said at least a first filter (1) and adapted to receive the waters introduced in counter-flow into said at least a first filter (1) by means of said first pump (2), said waters being then added with said products of the absorption of said pollutants by said activated carbon.

According to an embodiment, said system comprises a further filter (5) positioned downstream of said second tank (3) and adapted to further filter the outcoming waters from said second tank (3) and added with said products of the absorption of said pollutants by said activated carbon.

According to an embodiment, said further filter (5) is of the type comprising a filtering web or belt adapted to retain said products of the absorption of said pollutants by said activated carbon.

According to an embodiment, said filtering belt or web is removable, where the removal of said filtering belt or web results in the removal of said products of the absorption of said pollutants by said activated carbon from said further filter (5).

The present invention also relates to a system for treating the fumes generated by the combustion of heavy oil, said system comprising a scrubber and means for introducing water into said scrubber, where said system comprises a system according to one of the embodiments of the present invention, where said scrubber is placed in communication with said duct (C) upstream of said first tank (S) of activated carbon powders, and therefore where the outcoming waters from said scrubber are introduced into said duct (C) upstream of said first tank (S) of activated carbon powders.

The present invention also relates to a method for filtering waters contaminated by pollutants, in particular for removing heavy metals and/or PAHs from said contaminated waters by means of a system according to one of the embodiments of the present invention, said method comprising the steps of:

introducing said activated carbon powders into said duct (C);

filtering said polluted waters added with said activated carbon powders by means of said at least a first filter (1);

separating the products of the absorption of said pollutants by said activated carbon from said contaminated waters by means of said at least a first filter (1);

removing said retained products of the absorption of said pollutants by said activated carbon from said at least a first filter (1).

According to an embodiment, said step of removing said retained products of the absorption of said pollutants by said activated carbon from said at least a first filter (1) comprises withdrawing at least part of the outcoming waters from said at least a first filter (1), and re-introducing in counter-flow at least part of the water withdrawn at the outlet by said at least a first filter (1) into said at least a first filter (1).

According to an embodiment, said method comprises introducing the water introduced in counter-flow into said at least a first filter (1) into a second tank (3), said waters being thus added with said products of the absorption of said pollutants by said activated carbon, withdrawing the contained waters from said second tank (3), and filtering the waters withdrawn from said further tank (3) by means of a further filter (5).

According to an embodiment, said further filter (5) is of the type comprising a filtering belt or web adapted to retain said products of the absorption of said pollutants by activated carbon, where said filtering belt or web is removable, and where said method comprises removing said filtering belt or web from said further filter (5), and then removing said products of the absorption of said pollutants by said active carbon from said further filter (5).

### DESCRIPTION OF THE DRAWINGS

Further features and advantages of the invention will become more apparent from the following description of some preferred, but not exclusive, embodiments of the present invention depicted by way of indicative, non-limiting example in the drawings, in which:

FIG. 1 shows the diagram of a system for treating and/or filtering waters contaminated by pollutants according to an embodiment of the present invention;

FIG. 2 shows the diagram of the mutual arrangement of filters of the system according to an embedment of the present invention.

### DETAILED DESCRIPTION

The present invention finds particularly advantageous application in the treatment of waters discharged from marine scrubbers in order to remove or at least reduce the concentration of metals and/or PAHs (and/or any powders or particulate matter) contained therein and generated by the combustion of fuel oil, in particular heavy oil, this being the reason why the present invention will be described below with particular reference to the applications thereof in the field of the treatment of waters discharged from marine scrubbers for the above purposes. However, the applications of the present invention are not limited to the treatment of waters discharged from marine scrubbers; on the contrary, the present invention finds equally advantageous application in the field of the treatment of contaminated waters of any origin, in particular contaminated by heavy metals and/or PAHs.

The present invention derives from the consideration according to which the treatment of a dry sludge offers considerable advantages with respect to the treatment of liquid sludges produced in the systems according to the known art, said liquid sludges being very complex to store and/or dispose of.

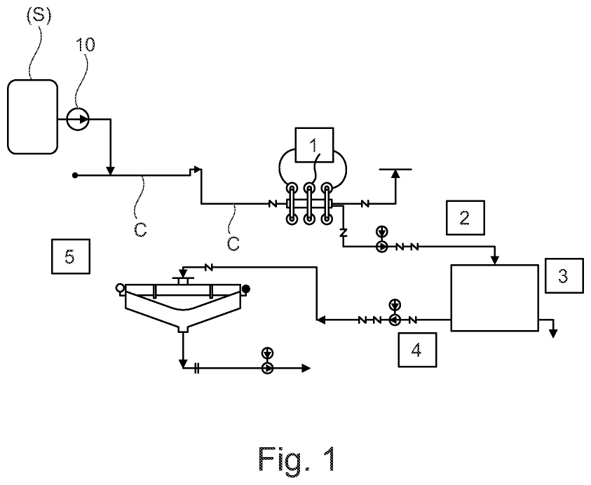

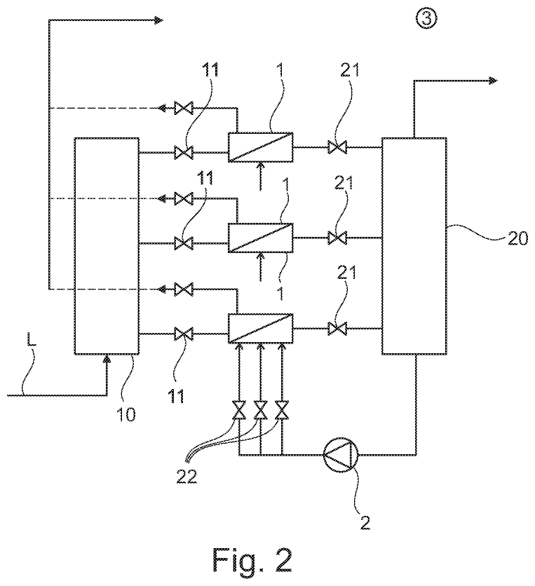

With reference to FIGS. 1 and 2, the system depicted therein comprises a duct C adapted to allow the transit of a liquid, in particular the waters coming from a scrubber (not shown), said duct C thus being capable of being placed in communication with the discharge of one said scrubber. The system further comprises a first tank S adapted to contain activated carbon powders, and a pump 10 interposed between the tank S and the duct C for introducing the activated carbon powders into the duct C. According to an embodiment of the present invention, said activated carbon powders can be introduced into the duct C possibly in the form of an aqueous solution. Downstream of the introduction point of the activated carbon powders into the duct C, means 11 are present, in communication with the duct C, for removing any gases present in the duct C, where via said means 11 (substantially a container), the gases accumulated inside the container 11 above the water contained therein, are discharged to the outside, thus freeing the duct C from any gases which could affect or decrease the filtration efficiency of the waters envisaged along the duct C (see the following description. However, it should be specified that the means 11 just described are not essential for the purposes of the present invention and, as a function of needs or circumstances, they can also be omitted. Downstream of the container 11 there is a set of three filters 1 (where the number of filters can vary from a minimum of one filter), said three filters 1 being arranged and mutually connected in parallel and being adapted to be alternatively placed in communication with the duct C (so as to receive the waters in transit in the duct C) and disconnected from the duct C. This solution allows the regeneration (according to the modes explained below) of the filters 1 temporarily disconnected from the duct C and the contemporary use of the filters 1 in communication with the duct C and affected by the waters in transit. The duct C ends with a discharge terminal (see the arrow at the end of the duct C for the discharge of the filtered water outflowing from the set of filters 1, for example for pouring said clean waters into the sea.

The reference numeral 2 in FIG. 1 also identifies a pump for regenerating the filters 1 by means of which, in particular, part of the clean waters outflowing from the filters 1 is withdrawn and returned in counter-flow (in the opposite direction to the flow of contaminated waters in the duct C) into one or more filters 1 temporarily disconnected from the duct C in which the products of absorption by the activated carbon introduced into the duct C and the heavy metals and/or PAHs (as well as any powders or particulate matter) contained in the waters in transit and captured in said one or more filters 1 have reached a predefined accumulation level such as to require, for the further use of said one or more filters 1, the removal of said products of the absorption of said heavy metals and/or PAHs (hereinafter possibly defined as “products of the absorption”) and any powders or particulate matter by said activated carbon accumulated in said one or more filters 1.

By means of the clean waters in counter-flow, said products of the absorption and said possible powders or particulate matter are removed from said one or more filters, where the outflowing waters in counter-flow from said one or more filters (said waters thus containing said products of the absorption of said heavy metals and/or PAHs and said possible powders or particulates by the activated carbon) are introduced into an intermediate tank 3. From the tank 3, by means of a further pump 4, the waters are introduced into an end filter 5 adapted to retain the products of the absorption of said heavy metals and/or PAHs and/or said possible powders or particulates by the activated carbon. The waters outflowing from the filter 5, therefore cleaned, can be discharged from the filter 5, for example poured into the sea. In particular, the end filter 5 is of the type comprising a removable web or belt adapted to retain said absorption products and/or said possible powders or particulates, therefore where the removal of the web or band from the filter 5 results in the removal from the filter 5 of the products of the absorption of heavy metals and/or PAHs and/or of any powders or particulate matter by the activated carbon, and thus in the cleaning of the filter 5, where the absorption products and any powders or particulates removed by said web or belt can be disposed of.

The operation of the system in FIG. 1, moreover at least in part anticipated above, can be described as follows.

By means of the pump 10, the activated carbon powders stored in the tank S are introduced into the duct C, thereby triggering the absorption by the activated carbon of the heavy metals and/or PAHs contained in solution (and thus dissolved) in the waters in transit in the duct C. The waters in transit in the duct C, at this point containing the products of the absorption of heavy metals and/or PAHs and any powders and/or particulate matter by the activated carbon are introduced into the filters 1 which thus retain both said absorption products and said powders and/or particulate matter, while the clean water outflowing from the filters can be poured into the sea, for example. By means of the pump 2, clean waters are reintroduced in counter-flow into the filters 1, thereby removing the accumulated and retained absorption products and/or said powders or particulates from the filters 1. The waters outflowing in counter-flow from the filters 1, thus containing the absorption products and any powders or particulate removed from the filters 1, are introduced into the tank 3 and from there into the end filter 5 adapted to separate said absorption products and said any powders or particulate matter from said waters, where the clean waters outflowing from the end filter 5 can for example be discharged into the sea.

With reference to FIG. 2, a description will be given below of the methods for mutually connecting the filters 1, as well as of the methods for connecting the filters 1 to the duct C.

As depicted, each of the filters 1 is interposed between an inlet or delivery manifold 10, connected to the duct C, and an outlet or discharge manifold 20. Furthermore, each of the filters 1 is interposed between a valve 11 and a valve 21, where the opening and closing according to methods which can be easily perceived from the diagram in FIG. 2, allow the communication between the manifold 10 and the manifold 20 (and thus the use of the filters 1) and the interruption of the connection between the manifold 10 and the manifold 20, and therefore the isolation of the filters 1, respectively.

As anticipated, the clean waters outflowing from the manifold 20, by means of the pump 2 and further valves 22, are partially selectively reintroduced in counter-flow into the filters 1 (those to be washed), where the water outflowing from the filters 1, in counter-flow with respect to the flow direction in the duct C, are introduced into the intermediate tank or container 3.

Thus, it has been demonstrated by the preceding description of the embodiments of the present invention, depicted in the drawings, that the present invention allows to achieve the preset objects and thus overcome the drawbacks found in the prior art.

In particular, as demonstrated, by means of the present invention a system is provided for the effective removal from contaminated waters of the heavy metals and/or PAHs contained therein and resulting for example but not exclusively from the combustion of fuel oil, in particular heavy oil.

Furthermore, the system and method according to the present invention allow to remove or at least reduce the concentration of heavy metals and/or PAHs, within the limits established by the regulations in force, from the waters discharged by marine scrubbers before they are poured into the sea.

Finally, the system and method according to the present invention are achievable and at low costs, respectively, according to methods which are simple and easy to perform, and allow the removal or at least the reduction of the concentration of heavy metals and/or PAHs from the waters discharged by different scrubbers and used on ships of different types for treating combustion fumes.

In this regard, it should be considered that, according to the known art, the activated carbon used in the industry for treating water (and possibly gas), is contained in a tank and placed on a fixed bed which is crossed by the flow of waters or gases to be treated. Considering that, for example in the case of the waters outflowing from marine scrubbers, the flow rates involved are decidedly high (hundreds of tons/hour), the tank with the bed of activated carbon would be of such dimensions as to compromise the installation thereof, in particular aboard ships.

On the contrary, by means of the system according to the present invention, only the installation of a tank for the storage of the powdered carbon is required, where the system requires only the periodic replacement of the filtering fabric from the end filter, thus being a much less demanding operation.

The present invention has been clarified above by means of the detailed description of the embodiments thereof depicted in the drawings; however, the present invention is not limited to the embodiments described above and depicted in the drawings but comprises all those variants of the described and depicted embodiments which will be immediate and obvious to those skilled in the art.

The scope of protection of the present invention is thus defined by the claims.

1. A filtering system for waters contaminated by pollutants, in particular for removing or at least reducing the concentration of heavy metals and/or PAHs from said contaminated waters, said system comprising a duct for the transit of said contaminated water, said system being characterized in that it comprises a tank for activated carbon powders in communication with said duct for the transit of said contaminated water by introduction means adapted to introduce said active carbon powders into said active duct, in that it comprises at least one filter for said polluted water with said activated carbon powders added in communication with said duct, said at least a first filter being adapted to separate the products of the absorption of said pollutants by said activated carbon from said contaminated water and to retain said absorption products.

2. The system according to claim 1, wherein it comprises at least two of said first filters adapted to separate said products of the absorption of said pollutants by said activated carbon from said contaminated waters and to retain said products of the absorption of said pollutants by said activated carbon, wherein said at least two first filters are arranged in parallel and thus alternatively connectable to and isolable from said duct, and therefore in that said contaminated water can be treated continuously by means of said at least two filters.

3. The kit system according to claim 2, wherein each of said at least two first filters is alternatively connectable to and isolable from said duct by means of at least one valve interposed between each of said at least two first filters and said duct.

4. The system according to claim 1, wherein it comprises means for removing any gases from said duct wherein said means for removing said possible gases are put in communication with said duct downstream of the introduction point of said activated carbon powders into said duct and upstream of said at least a first filter for said polluted waters added with said activated carbon powders.

5. The system according to claim 1, wherein it comprises means for regenerating said at least one filter adapted to remove said retained products of the reaction between said activated carbon and said pollutants from said at least a first filter.

6. The system according to claim 5, wherein said means for regenerating said at least one filter comprise a first pump in communication with said duct downstream of said at least a first filter wherein said first pump is thus adapted to at least partially withdraw the outcoming waters from said at least a first filter and wherein said first pump is in communication with said at least a first filter and adapted to reintroduce at least part of the outcoming waters from said at least a first filter in said at least a first filter and then to remove said retained products of the absorption of said pollutants by said activated carbon from said at least a first filter.

7. The system according to claim 6, wherein it comprises a second tank in communication with said at least a first filter and adapted to receive the waters introduced in counter-flow into said at least a first filter by means of said first pump, said waters being then added with said products of the absorption of said pollutants by said activated carbon.

8. The system according to claim 7, wherein it comprises a further filter positioned downstream of said second tank and adapted to further filter the outcoming waters from said second tank and added with said products of the absorption of said pollutants by said activated carbon.

9. The system according to claim 8, wherein said further filters is of the type comprising a filtering web or belt adapted to retain said products of the absorption of said pollutants by said activated carbon.

10. The system according to claim 9, wherein said filtering belt or web is removable, wherein the removal of said filtering belt or web results in the removal of said products of the absorption of said pollutants by said activated carbon from said further filter.

11. The A-system for treating fumes generated by the combustion of heavy oil, said system comprising a scrubber and means for introducing water into said scrubber, wherein it comprises a system according to claim 1, said scrubber is placed in communication with said duct upstream of said first tank for activated carbon powders, and therefore wherein the outcoming waters from said scrubber are introduced into said duct upstream of said first tank for activated carbon powders.

12. A method for filtering waters contaminated by pollutants, in particular for removing heavy metals and/or PAHs from said contaminated waters by means of a system according to claim 1, said method comprising the steps of:
introducing said activated carbon powders into said duct;
filtering said polluted waters added with said activated carbon powders by means of said at least a first filter;
separating the products of the absorption of said pollutants by said activated carbon from said contaminated waters by means of said at least a first filter;
removing said retained products of the absorption of said pollutants by said activated carbon from said at least a first filter.

13. The method according to claim 12, wherein said step of removing said retained products of the absorption of said pollutants by said activated carbon from said at least a first filter comprises withdrawing at least part of the outcoming waters from said at least a first filter, and re-introducing in counter-flow at least part of the water withdrawn at the outlet from said at least a first filter into said at least a first filter.

14. The method according to claim 13, wherein it comprises introducing the water introduced in counter-flow into said at least a first filter into a second tank, said waters being thus added with said products of the absorption of said pollutants by said activated carbon, withdrawing the contained waters from said second tank, and filtering the waters withdrawn from said further tank by means of a further filter.

15. A method according to claim 14, said further filter is of the type comprising a filtering belt or web adapted to retain said products of the absorption of said pollutants by activated carbon, am, said filtering belt or web is removable, and wherein said method comprises removing said filtering belt or web from said further filter, and then removing said products of the absorption of said pollutants by said active carbon from said further filter.
